(19) United States
(12) Patent Application Publication
(10) Pub. No.: US 2025/0084544 A1
(43) Pub. Date: Mar. 13, 2025

(54) SOLID OXIDE CELL AND MANUFACTURING METHOD THEREOF

(71) Applicant: SAMSUNG ELECTRO-MECHANICS CO., LTD., Suwon-si, Gyeonggi-do (KR)

(72) Inventors: Jungdeok Park, Suwon-si, Gyeonggi-do (KR); Jaeseok Yi, Suwon-si, Gyeonggi-do (KR); Hongryul Lee, Suwon-si, Gyeonggi-do (KR); Jaehyuk Jang, Suwon-si, Gyeonggi-do (KR)

(73) Assignee: SAMSUNG ELECTRO-MECHANICS CO., LTD., Suwon-si, Gyeonggi-do (KR)

(21) Appl. No.: 18/287,815

(22) PCT Filed: Sep. 25, 2023
(86) PCT No.: PCT/KR2023/014693

§ 371 Date: Oct. 20, 2023

(30) Foreign Application Priority Data
Dec. 6, 2022 (KR) 10-2022-0168884
Mar. 31, 2023 (KR) 10-2023-0042583

(51) Int. Cl. C25B 11/031; C25B 9/19; C25B 9/77; C25B 13/07; H01M 4/86; H01M 8/12; H01M 8/2404; H01M 8/2432

(52) U.S. Cl. CPC C25B 11/031; C25B 9/19; C25B 9/77; C25B 13/07; H01M 4/8626; H01M 8/2404; H01M 8/2432; H01M 2008/1293

(57) ABSTRACT

A solid oxide cell according to an embodiment includes: a fuel electrode and an air electrode that face each other; and an electrolyte electrode that is disposed between the fuel electrode and the air electrode. The fuel electrode has a plate shape, an edge of the fuel electrode is rounded along a thickness direction of the fuel electrode, the fuel electrode includes a central layer and an outer layer disposed on both sides of the central layer, and a first porosity, which is a porosity of the central layer of the fuel electrode, is smaller than a second porosity, which is a porosity of the outer layer of the fuel electrode.

### TECHNICAL FIELD

The present disclosure relates to a solid oxide cell and a manufacturing method thereof.

### BACKGROUND ART

In general, a solid oxide cell (SOC) includes a solid oxide electrolysis cell (SOEC) and a solid oxide fuel cell (SOFC) having roughly the same structure.

The solid oxide electrolysis cell (SOEC) is a device that generates hydrogen by electrolyzing water, and it is possible to produce green hydrogen by using electricity generated by renewable energy such as solar and wind power and is essential for carbon neutrality and hydrogen economy. In particular, the solid oxide electrolysis cell (SOEC) is an environmentally-friendly energy conversion device with high efficiency due to high temperature operation and no carbon discharge.

In addition, the solid oxide fuel cell (SOFC) is a device that produces electricity by using the reverse reaction of the electrolysis reaction of water, and has several merits that it has high power generation efficiency because the non-reversible loss is small, a wide fuel selection range include not only hydrogen but also carbon or hydrocarbon-based fuel because various fuels can be used without a reformer, a fast reaction speed at the electrode and thus it does not require expensive a noble metal catalysts.

An electrolyte and an electrode of a unit cell used in the solid oxide electrolysis cell (SOEC) and the solid oxide fuel cell (SOFC) can be formed of solid oxide.

In particularly, a flat-plate solid oxide cell (SOC) may contain a fuel electrode, an electrolyte electrode, and an air electrode in a flat shape. In this case, the fuel electrode may be applied as a fuel electrode support that is thicker and has a wider area than the electrolyte electrode and air electrode.

Edges and corners of the fuel electrode, electrolyte electrode, and air electrode of the flat-type solid oxide cell have a right angle and sharp-angled shape, and thus when a stack is formed by stacking unit cells, the edges and corners are likely to be impacted to wear or damage.

In addition, when the unit cells are laminated, stress and pressure are concentrated on sharp edges and corners due to contact with sealing materials or clamping pressure, and thus the edges and corners are likely to be damaged.

### DISCLOSURE OF INVENTION

### Technical Problem

Embodiments are to provide a solid oxide cell that can minimize a damage during stack manufacturing by distributing pressure and stress applied to edges and corners, and a manufacturing method thereof.

However, the problem to be solved by the embodiments may be variously extended in the range of technical ideas included in the embodiments without being limited to the above-described problems.

### Solution to Problem

A solid oxide cell according to an embodiment includes: a fuel electrode and an air electrode that face each other; and an electrolyte electrode that is disposed between the fuel electrode and the air electrode. The fuel electrode may have a plate shape, an edge of the fuel electrode may be rounded along a thickness direction of the fuel electrode, the fuel electrode may include a central layer and an outer layer disposed on both sides of the central layer, and a first porosity, which is a porosity of the central layer of the fuel electrode, may be smaller than a second porosity, which is a porosity of the outer layer of the fuel electrode.

A first corner, which is a corner connecting edges of the fuel electrode, may be rounded along the thickness direction of the fuel electrode.

The first corner may be rounded on a plane crossing the thickness direction of the fuel electrode.

The edge of the fuel electrode may have a curvature radius which is a range of ¼ to 1 of the thickness of the fuel electrode.

A second corner, a corner of the electrolyte electrode, and a third corner, a corner of the air electrode, may be rounded on a plane crossing the thickness direction of the fuel electrode.

A curvature radius of each of the first corner, the second corner, and the third corner on a plane crossing the thickness direction of the fuel electrode may be a range of 0.1 mm to 2 mm.

The fuel electrode may further include a middle layer disposed between the central layer and the outer layer and having a third porosity, and the third porosity may be greater than the first porosity and less than the second porosity.

A length of the middle layer may be longer than a length of the outer layer and shorter than a length of the central layer.

In addition, a manufacturing method of a solid oxide cell according to an embodiment includes: stacking and compressing a plurality of fuel electrode members including a central member and an outer member disposed on both sides of the central member; stacking an electrolyte member on the fuel electrode member; sintering the plurality of fuel electrode members and the electrolyte member to form the fuel electrode and electrolyte electrode to round an edge of the fuel electrode along a thickness direction of the fuel electrode and to have a first porosity, which is a porosity of a central layer formed of the central member, being smaller than a second porosity, which is a porosity of the outer layer formed of the outer member; and forming an air electrode on the electrolyte electrode.

The outer member may shrink more than the central member by sintering the plurality of fuel electrode members such that a length of the outer layer formed by sintering the outer member may be shorter than a length of the central layer formed by sintering the central member.

The preparing the plurality of fuel electrode members may include forming a first corner, which is a corner of the plurality of fuel electrode members, to be round on a plane crossing the thickness direction of the fuel electrode.

The stacking the electrolyte member may include forming a second corner, which is a corner of the electrolyte member, to be round on a plane crossing the thickness direction of the fuel electrode.

The forming the air electrode may include forming a third corner, which is a corner of the air electrode, to be round on a plane crossing the thickness direction of the fuel electrode.

A solid oxide cell according to an embodiment includes: a fuel electrode and an air electrode that face each other; and an electrolyte electrode that is disposed between the fuel electrode and the air electrode. The fuel electrode may have a plate shape, and a central portion of the fuel electrode may be longer than a portion of the fuel electrode which is closer to the electrolyte electrode than the central portion.

A first corner, which is a corner connecting edges of the fuel electrode, may be rounded along a thickness direction of the fuel electrode.

A curvature radius of the fuel electrode may be a range of 0.1 mm to 2 mm.

A second corner, a corner of the electrolyte electrode, and a third corner, a corner of the air electrode, may be rounded on a plane crossing the thickness direction of the fuel electrode.

A length of the fuel electrode may decrease in a direction from the central portion of the fuel electrode to the portion of the fuel electrode which is closer to the electrolyte electrode than the central portion.

A porosity of the fuel electrode may increase in a direction from the central portion of the fuel electrode to the portion of the fuel electrode which is closer to the electrolyte electrode than the central portion.

A length of the electrolyte electrode may be greater than a length of the air electrode and less than a length of the fuel electrode.

### Advantageous Effects of Invention

According to the embodiments, the first porosity, which is the porosity of the central layer of the fuel electrode, is smaller than the second porosity, which is the porosity of the outer layer of the fuel electrode such that the edges and corners of the fuel electrode can be rounded along the thickness direction of the fuel electrode.

Therefore, it is possible to minimize damage to the fuel electrode during stack manufacturing by distributing the pressure and stress applied to the edges and corners of the fuel electrode.

In addition, by forming the corners of the electrolyte electrode and air electrode to be round, the pressure and stress applied to the corners of the electrolyte electrode and air electrode can be dispersed to minimize damage to the electrolyte electrode and air electrode during stack manufacturing.

However, it is clear that the effects of the embodiments are not limited to the above-described effects, and can be variously extended within a range that does not deviate from the spirit and region of the present invention.

### BRIEF DESCRIPTION OF DRAWINGS

FIG. 1 is a schematic perspective view of a solid oxide cell according to an embodiment.

FIG. 2 is a top plan view of FIG. 1.

FIG. 3 is a cross-sectional view of FIG. 2, taken along the line III-III′.

FIG. 4 is an enlarged cross-sectional view of the portion A in FIG. 3.

FIG. 5 is a partially enlarged photo of the center layer and the middle layer of FIG. 4.

FIG. 6 and FIG. 7 are provided for description of one step of a method for manufacturing the solid oxide cell according to an embodiment.

### MODE FOR THE INVENTION

Hereinafter, with reference to accompanying drawings, various embodiments of the present invention will be described in detail and thus a person of an ordinary skill can easily practice them in the technical field to which the present invention belongs. The present invention may be embodied in many different forms and is not limited to the embodiments described herein.

In order to clearly explain the present invention, parts irrelevant to the description have been omitted, and the same reference numerals are used for the same or similar constituent elements throughout the specification.

In addition, the attached drawing is only for easy understanding of the embodiment disclosed in the present specification, and the technical idea disclosed in the present specification is not limited by the attached drawing, and all changes included in the spirit and technical range of the present invention should be understood to include equivalents or substitutes.

In addition, since the size and thickness of each component shown in the drawing are arbitrarily indicated for better understanding and ease of description, the present invention is not necessarily limited thereto. In the drawings, the thickness of layers and regions are exaggerated for clarity. In the drawings, the thickness of layers, films, panels, regions, and the like are exaggerated for convenience of description.

It will be understood that when an element such as a layer, film, region, or substrate is referred to as being “on” another element, it can be directly on the other element or intervening elements may also be present. In contrast, when an element is referred to as being “directly on” another element, there are no intervening elements present. Further, throughout the specification, the word “on” a target element will be understood to mean positioned above or below the target element, and will not necessarily be understood to mean positioned “at an upper side” based on an opposite to gravity direction.

In addition, unless explicitly described to the contrary, the word “comprise”, and variations such as “comprises” or “comprising”, will be understood to imply the inclusion of stated elements but not the exclusion of any other elements.

Further, throughout the specification, the phrase “on a plane” means viewing a target portion from the top, and the phrase “on a cross-section” means viewing a cross-section formed by vertically cutting a target portion from the side.

In addition, when “connected to” in the entire specification, this does not only mean that two or more constituent elements are directly connected, but also means that two or more constituent elements are indirectly connected, physically connected, and electrically connected through other constituent elements, or being referred to by different names depending on the position or function, while being integral.

Hereinafter, various embodiments and exemplary variations will be described in detail with reference to the drawings.

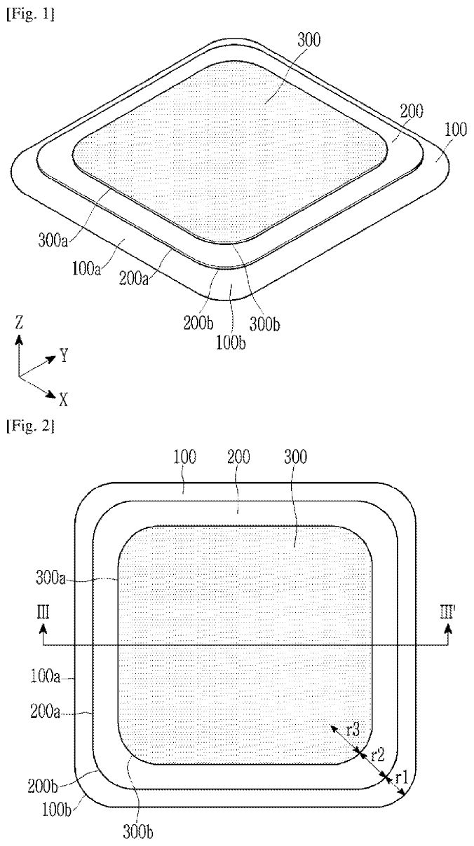

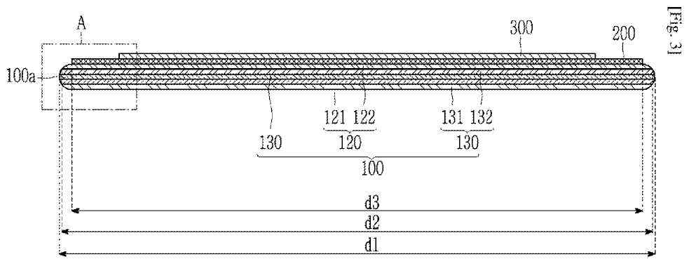

FIG. 1 is a schematic perspective view of a solid oxide cell according to an embodiment, FIG. 2 is a top plan view of FIG. 1, FIG. 3 is a cross-sectional view of FIG. 2, taken along the line III-III′, and FIG. 4 is an enlarged cross-sectional view of the portion A in FIG. 3.

As shown in FIG. 1 to FIG. 3, a solid oxide cell according to an embodiment includes a fuel electrode 100, an electrolyte layer 200, and an air electrode 300 that are sequentially stacked.

The size and thickness of the fuel electrode 100 may be larger than the size and thickness of the electrolyte electrode 200 and the air electrode 300. Thus, the fuel electrode 100 may support the stacked electrolyte electrode 200 and air electrode 300. In the case of a solid oxide electrolysis cell (SOEC) the fuel electrode 100 may generate hydrogen gas and oxygen ions through electrolysis by receiving fuel gas such as water (H₂O) in a reducing atmosphere.

Since the fuel electrode 100 has a square flat plate shape, it may have four edges 100a and a first corner 100b that connects the four edges 100a to each other.

The edge 100a of the fuel electrode 100 is rounded along a thickness direction Z of the fuel electrode 100, and the first corner 100b of the fuel electrode 100 may also be rounded along the thickness direction Z of the fuel electrode 100.

Therefore, compared to the case where the edge 100a of the fuel electrode 100 has a straight-line shape, the area of the edge 100a of the fuel electrode 100 increases, and the pressure per unit area decreases. Therefore, strength can be increased in physical impact by pressure. As described, by distributing the pressure and stress applied to the edge 100a and the first corner 100b of the fuel electrode 100, damage to the fuel electrode 100 during stack manufacturing can be minimized.

As shown in FIG. 3 and FIG. 4, the fuel electrode 100 may include a central layer 110, a middle layer 130, and an outer layer 120 that are stacked.

The central layer 110 is disposed in a center and may have a first shortest length d1. The middle layer 130 includes a first middle layer 131 and a second middle layer 132 disposed opposite to both sides of the center layer 110, respectively, and may have a second shortest length d2. The outer layer 120 includes a first outer layer 121 and a second outer layer 122 disposed opposite to both sides of the middle layer 130, respectively, and may have a third shortest length d3.

The fuel electrode 100 is a solid oxide with ion conductivity, and may include a metal oxide such as yttria stabilized zirconia ZrC₂ (YSZ) in which yttria Y₂O₃ is dissolved in zirconia ZrO₂, scandium stabilized zirconia (ScSZ), GDC, and LDC. However, the fuel electrode 100 is not limited thereto and may be made of various materials.

FIG. 5 is a partially enlarged photo of the center layer and the middle layer of FIG. 4.

As shown in FIG. 5, the fuel electrode 100 may have a plurality of pores AG serving as a gas movement path. A first porosity, which is a porosity of the central layer 110 of the fuel electrode 100, is smaller than a second porosity, which is a porosity of the outer layer 120 of the fuel electrode 100, and a third porosity, which is a porosity of the middle layer 130 of the fuel electrode 100, is greater than the first porosity and smaller than the second porosity. Therefore, the outer layer 120 having the largest porosity may shrink more than the center layer 110 and the middle layer 130 in a sintering process.

As shown in FIG. 4, the central layer 110 is contracted by a first contraction length W1, but the outer layer 120 may be contracted by a second contraction length W2 that is shorter than the first contraction length W1. In addition, the middle layer 130 may be contracted by a third contraction length W3 that is longer than the first contraction length W1 and shorter than the second contraction length W2. Therefore, the edge 100a of the fuel electrode 100 may be rounded along the thickness direction (Z) of the fuel electrode 100.

In this case, the edge 100a of the fuel electrode 100 may have a curvature radius (R) of ½ of a thickness D of the fuel electrode 100 and may be rounded along the thickness direction (Z) of the fuel electrode 100. In one example, the curvature radius (R) of the fuel electrode 100 may be in a range of ¼ of the thickness D to the thickness D.

If the curvature radius (R) of the fuel electrode 100 is smaller than ¼ of the thickness D, it may be vulnerable to stress in the thickness direction (Z), and if the curvature radius (R) of the fuel electrode 100 is larger than the thickness (D), the effect of stress distribution is reduced.

As such, the first porosity of the central layer 110 of the fuel electrode 100 is formed to be smaller than the second porosity of the outer layer 120 of the fuel electrode 100, and thus the edge 100a and the first corner 100b of the fuel electrode 100 may be rounded in the thickness direction (Z).

The first corner 100b of the fuel electrode 100 may be round on a plane. Therefore, damage to the fuel electrode 100 during stack manufacturing can be minimized by further distributing the pressure and stress applied to the first corner 100b of the fuel electrode 100.

Meanwhile, in the case of a solid oxide electrolysis cell (SOEC), the electrolyte electrode 200 may transmit oxygen ions generated from the fuel electrode 100 to the air electrode 300.

Since the electrolyte electrode 200 has a square flat plate shape, it may have four edges 200a and four second corners 200b, that are four corners connecting the four edges 200a to each other.

The second corner 200b of the electrolyte electrode 200 may be rounded on a plane. Therefore, damage to the electrolyte electrode 200 can be minimized during stack manufacturing by distributing the pressure and stress applied to the second corner 200b of the electrolyte electrode 200.

In the case of a solid oxide electrolysis cell (SOEC), the air electrode 300 may generate oxygen gas by oxidizing oxygen ions transmitted from the electrolyte electrode 200 in an oxidizing atmosphere.

The air electrode 300 may be formed by coating using a plasma spray method using lanthanum strontium manganite ((La_{0.84} Sr_{0.16}) MnO₃) with high electron conductivity, a dry method such as an electrochemical deposition method, a sputtering method, an ion beam method, an ion implantation method, and the like, a wet method such as tape casting, spray coating, dip coating, screen printing, doctor blade, and the like, and then performing sintering at about 1200° C. to about 1300° C. However, the air electrode 300 is not limited thereto, and may be made of various materials.

Since the air electrode 300 has a square flat plate shape, it may have four edges 300a and four third corners 300b that connect the four edges 300a to each other.

The third corner 300b of the air electrode 300 may be rounded on a plane. Therefore, damage to the air electrode can be minimized during stack manufacturing by distributing the pressure and stress applied to the third corner 300b of the air electrode 300.

The first corner 100b, the second corner 200b, and the third corner 300b may have the same curvature radius r1, r2, and r3 on a plane crossing the thickness direction of the fuel electrode. Therefore, damage to the fuel electrode 100, electrolyte electrode 200, and air electrode can be further minimized by evenly distributing the pressure and stress applied to the first corner 100b, second corner 200b, and third corner 300b.

Here, each of a curvature radius r1 of the first corner 100b, a curvature radius r2 of the second corner 200b, and a curvature radius r3 of the third corner on a plane may be a range of 0.1 mm to 2 mm.

If the curvature radius r1, r2, and r3 are smaller than 0.1 mm, the effect of stress distribution is reduced. If the curvature radii r1, r2, and r3 are larger than 2 mm, the areas of the fuel electrode 100, electrolyte electrode 200, and air electrode may be reduced, thereby deteriorating battery performance.

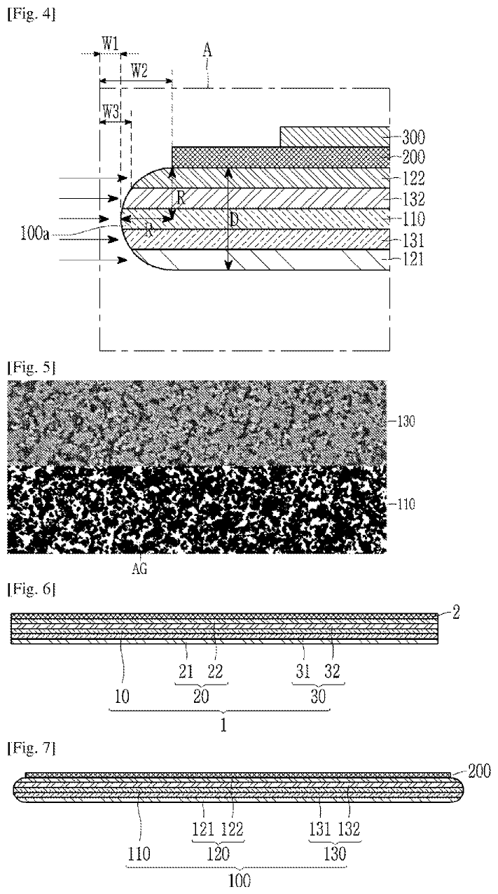

Next, referring to FIG. 6 and FIG. 7, together with FIG. 1 to FIG. 4, a manufacturing method of the solid oxide cell according to an embodiment will be described in detail.

FIG. 6 and FIG. 7 are provided for description of one step of a method for manufacturing the solid oxide cell according to an embodiment.

As shown in FIG. 6, according to the manufacturing method of the solid oxide cell according to an embodiment, a plurality of fuel electrode members 1 having a square flat shape are prepared. The plurality of fuel electrode members 1 may have the same size and thickness. A first corner 100b of the plurality of fuel electrode member 1 may be formed to be round on a plane.

The plurality of fuel electrode members 1 may include a central member 10, a middle member 30, and an outer member 20. The central member 10 may have a first porosity. The middle member 30 may have a higher third porosity than the first porosity. The outer member 20 may have a second porosity greater than the third porosity.

Then, the plurality of fuel electrode members 1 are stacked. In this case, the central member 10 may be disposed at a center. The middle member 30 may include a first middle member 31 and a second middle member 32 disposed opposite to both sides of the central member 10, respectively. The outer member 20 may include a first outer member 21 and a second outer member 22 disposed opposite to both sides of the middle member 30, respectively.

In addition, the plurality of fuel electrode members 1 may be attached to each other by compressing the plurality of fuel electrode members 1.

In addition, the electrolyte member 2 is stacked on the fuel electrode member 1. In this case, the second corner of electrolyte member 2 may be formed to be round on a plane.

In addition, a shrinkage process such as sintering the plurality of fuel electrode members 1 and the electrolyte member 2 may be performed to form a fuel electrode 100 and an electrolyte electrode 200.

When the plurality of fuel electrode member 1 are sintered, the outer member 20 having a large porosity may contract more than the middle member 10 having a small porosity. Accordingly, a third shortest length d3 (refer to FIG. 3) of the outer layer 120 formed by sintering the outer member 20 may be shorter than the first shortest length d1 of the central layer 110 formed by sintering the middle member 10.

In addition, the second shortest length d2 (refer to FIG. 3) of the middle layer 130 formed by sintering the middle member 30 may be shorter than the first shortest length d1 of the central layer 110 and longer than the third shortest length d3 of the outer layer 120.

Therefore, the edge 100a and the first corner 100b of the fuel electrode 100 may be rounded along the thickness direction (Z) of the fuel electrode 100.

Then, the air electrode 300 is formed on the electrolyte electrode 200. In this case, the third corner 300b of the air electrode 300 may be formed to be round on a plane.

While this invention has been described in connection with what is presently considered to be practical embodiments, it is to be understood that the invention is not limited to the disclosed embodiments. On the contrary, it is intended to cover various modifications and equivalent arrangements included within the spirit and scope of the appended claims.

1. A solid oxide cell comprising:
a fuel electrode and an air electrode that face each other; and
an electrolyte electrode that is disposed between the fuel electrode and the air electrode,
wherein the fuel electrode has a plate shape,
an edge of the fuel electrode is rounded along a thickness direction of the fuel electrode,
the fuel electrode includes a central layer and an outer layer disposed on both sides of the central layer, and
a first porosity, which is a porosity of the central layer of the fuel electrode, is smaller than a second porosity, which is a porosity of the outer layer of the fuel electrode.

2. The solid oxide cell of claim 1, wherein:
a first corner, which is a corner connecting edges of the fuel electrode, is rounded along the thickness direction of the fuel electrode.

3. The solid oxide cell of claim 2, wherein:
the first corner is rounded on a plane crossing the thickness direction of the fuel electrode.

4. The solid oxide cell of claim 3, wherein:
the edge of the fuel electrode has a curvature radius which is a range of ¼ to 1 of the thickness of the fuel electrode.

5. The solid oxide cell of claim 3, wherein:
a second corner, a corner of the electrolyte electrode, and a third corner, a corner of the air electrode, are rounded on a plane crossing the thickness direction of the fuel electrode.

6. The solid oxide cell of claim 5, wherein:
a curvature radius of each of the first corner, the second corner, and the third corner on a plane crossing the thickness direction of the fuel electrode is a range of 0.1 mm to 2 mm.

7. The solid oxide cell of claim 1, wherein:
the fuel electrode further comprises a middle layer disposed between the central layer and the outer layer and having a third porosity, and the third porosity is greater than the first porosity and less than the second porosity.

8. The solid oxide cell of claim 7, wherein:
a length of the middle layer is longer than a length of the outer layer and shorter than a length of the central layer.

9. A manufacturing method of a solid oxide cell, comprising:
preparing a plurality of fuel electrode members of plate shape including a central member and an outer member disposed on both sides of the central member;
stacking and compressing the plurality of fuel electrode members;
stacking an electrolyte member on the fuel electrode member;
sintering the plurality of fuel electrode members and the electrolyte member to form the fuel electrode and electrolyte electrode to round an edge of the fuel electrode along a thickness direction of the fuel electrode and to have a first porosity, which is a porosity of a central layer formed of the central member, being smaller than a second porosity, which is a porosity of the outer layer formed of the outer member; and
forming an air electrode on the electrolyte electrode.

10. The manufacturing method of the solid oxide cell of claim 9, wherein:
by sintering the plurality of fuel electrode members,
the outer member shrinks more than the central member such that a length of the outer layer formed by sintering the outer member is shorter than a length of the central layer formed by sintering the central member.

11. The manufacturing method of the solid oxide cell of claim 10, wherein:
the preparing the plurality of fuel electrode members comprises forming a first corner, which is a corner of the plurality of fuel electrode members, to be round on a plane crossing the thickness direction of the fuel electrode.

12. The manufacturing method of the solid oxide cell of claim 11, wherein:
the stacking the electrolyte member comprises
forming a second corner, which is a corner of the electrolyte member, to be round on a plane crossing the thickness direction of the fuel electrode.

13. The manufacturing method of the solid oxide cell of claim 12, wherein:
the forming the air electrode comprises
forming a third corner, which is a corner of the air electrode, to be round on a plane crossing the thickness direction of the fuel electrode.

14. A solid oxide cell comprising:
a fuel electrode and an air electrode that face each other; and
an electrolyte electrode that is disposed between the fuel electrode and the air electrode,
wherein the fuel electrode has a plate shape, and
a central portion of the fuel electrode is longer than a portion of the fuel electrode which is closer to the electrolyte electrode than the central portion.

15. The solid oxide cell of claim 14, wherein:
a first corner, which is a corner connecting edges of the fuel electrode, is rounded along a thickness direction of the fuel electrode.

16. The solid oxide cell of claim 15, wherein:
wherein a curvature radius of the fuel electrode is a range of 0.1 mm to 2 mm.

17. The solid oxide cell of claim 15, wherein:
a second corner, a corner of the electrolyte electrode, and a third corner,
a corner of the air electrode, are rounded on a plane crossing the thickness direction of the fuel electrode.

18. The solid oxide cell of claim 14, wherein:
a length of the fuel electrode decreases in a direction from the central portion of the fuel electrode to the portion of the fuel electrode which is closer to the electrolyte electrode than the central portion.

19. The solid oxide cell of claim 14, wherein:
a porosity of the fuel electrode increases in a direction from the central portion of the fuel electrode to the portion of the fuel electrode which is closer to the electrolyte electrode than the central portion.

20. The solid oxide cell of claim 14, wherein:
a length of the electrolyte electrode is greater than a length of the air electrode and less than a length of the fuel electrode.
